(19) United States
(12) Patent Application Publication
(10) Pub. No.: US 2025/0054238 A1
(43) Pub. Date: Feb. 13, 2025

(54) Method and Apparatus for Reconstructing Semantic Instance, Device, and Medium

(71) Applicant: SHANDONG MASS INFORMATION TECHNOLOGY RESEARCH INSTITUTE, Shandong (CN)

(72) Inventors: Lihua LU, Suzhou, Jiangsu (CN); Hui WEI, Suzhou, Jiangsu (CN); Ruyang LI, Suzhou, Jiangsu (CN); Yaqian ZHAO, Suzhou, Jiangsu (CN); Rengang LI, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/722,890

(22) PCT Filed: Feb. 28, 2023
(86) PCT No.: PCT/CN2023/078805

§ 371 Date: Jun. 21, 2024

(30) Foreign Application Priority Data
Jun. 16, 2022 (CN) 202210677281.9

(51) Int. Cl. G06T 17/20; G06T 7/13; G06T 7/70; G06V 10/44; G06V 10/80

(52) U.S. Cl. CPC G06T 17/20; G06T 7/13; G06T 7/70; G06V 10/44; G06V 10/806; G06T 2207/10024; G06T 2207/20084

(57) ABSTRACT

A method and apparatus for reconstructing semantic instance, a device and medium, which relate to the field of three-dimensional vision. The method comprises: processing an original image by using a first target detection network to obtain first feature information of a target object, and processing a three-dimensional point cloud by using a second target detection network to obtain second feature information; predicting a first coarse point cloud on the basis of the first feature information, and predicting a three-dimensional detection result on the basis of the first feature information and the second feature information, so as to obtain a second coarse point cloud; and obtaining an initial point cloud of the target object on the basis of the first coarse point cloud and the second coarse point cloud, and processing the initial point cloud by using preset shape generation network to obtain semantic instance reconstruction result of the target object.

### CROSS-REFERENCE TO RELATED APPLICATION

The present disclosure claims priority to Chinese Patent Application No. 202210677281.9, filed to the China National Intellectual Property Administration on Jun. 16, 2022 and entitled “Method and Apparatus for Reconstructing Semantic Instance, Device, and Medium”, which is incorporated herein by reference in its entirety.

### TECHNICAL FIELD

The present disclosure relates to the field of three-dimensional vision, and in particular, to a method and apparatus for reconstructing semantic instance, a device, and a medium.

### BACKGROUND

When devices such as a depth camera scans a three-dimensional real scene, a scanning result is incomplete due to reasons such as blocking, limitation of a viewing angle, and poor light, etc. A task for reconstructing semantic instance couples three-dimensional semantic understanding and three-dimensional reconstruction, and the purpose thereof is to repair an incomplete scene scanning result, to perform reconstruction to obtain a complete geometric shape, the posture and category information of an object, thereby providing a basis for three-dimensional scene understanding, and being widely applied in fields such as intelligent driving, robot, virtual reality and augmented reality, etc. Current methods for reconstructing semantic instance are mostly based on a single modality, and may be mainly classified into two types: based on an RGB (Red Green Blue) map and based on a three-dimensional point cloud. In an RGB map-based method for reconstructing semantic instance, target detection and instance reconstruction are performed by using an RGB map, for example, a Mesh R-CNN (Mesh Region-Convolutional Neural Network) framework generates a reconstructed mesh of an object by improving an instance segmentation framework Mask R-CNN (Mask Region-Convolutional Neural Network) to increase mesh prediction branches; wherein target detection, instance segmentation and object mesh prediction may be realized by using the RGB map; however, using only the RGB map will cause depth ambiguity, resulting in situations such as a target positioning error, etc. In a three-dimensional point cloud-based method for reconstructing semantic instance, object detection and reconstruction quality may be improved by utilizing geometrical information provided by point cloud. For example, in a DOPS (Distributional Optimization from Samples) model proposed by Najibi et al., semantic instance reconstruction was achieved on a point cloud for the first time, but meshing processing is performed on the point cloud, limiting the resolution of instance reconstruction. Thereafter, Nie et al. proposed an RfD-Net (Reconstruction From Detection-Net) framework, which may directly learn semantic information of an object from an original point cloud, and reconstruct a geometric shape of the object. Although the described methods achieve good effects, the described methods still has the problems of a low accuracy of positioning of the location of an object and a low quality of a semantic instance reconstruction result.

In conclusion, in a task for reconstructing semantic instance, how to accurately position the location of an object and how to improve the quality of a semantic instance reconstruction result are problems to be solved currently.

### SUMMARY

Some embodiments of the present disclosure provide a method for reconstructing semantic instance, comprising:
an original image of a target scene is processed by using a first target detection network to obtain first feature information of a target object, and a three-dimensional point cloud of the target scene is processed by using a second target detection network to obtain second feature information of the target object;
a first coarse point cloud of the target object is predicted on the basis of the first feature information, and a three-dimensional detection result of the target object is predicted on the basis of the first feature information and the second feature information, so as to obtain a second coarse point cloud of the target object on the basis of the three-dimensional detection result; and
an initial point cloud of the target object is obtained on the basis of the first coarse point cloud and the second coarse point cloud, and the initial point cloud is processed by using a preset shape generation network to obtain a semantic instance reconstruction result of the target object.

In some embodiments of the present disclosure, the original image of the target scene is processed by using the first target detection network to obtain first feature information of the target object, comprises:
the original image of the target scene is processed by using a Faster R-CNN, to obtain two-dimensional feature information of the target object.

In some embodiments of the present disclosure, the original image of the target scene is processed by using the Faster R-CNN, to obtain two-dimensional feature information of the target object, comprises:
feature extraction is performed on the original image of the target scene by using a convolutional layer of the Faster R-CNN, and a first preset number of pieces of two-dimensional feature information comprising location information and semantic category information of the target object is outputted by using an activation function.

In some embodiments of the present disclosure, a first coarse point cloud of the target object is predicted on the basis of the first feature information, comprises:
a first coarse point cloud of the target object is predicted by using a point generation network on the basis of the location information and the semantic category information.

In some embodiments of the present disclosure, the method for reconstructing semantic instance further comprises:
a semantic instance reconstruction network comprising the first target detection network, the second target detection network, the point generation network and the preset shape generation network is constructed on the basis of a three-dimensional target detection network and a three-dimensional object reconstruction network.

In some embodiments of the present disclosure, the method for reconstructing semantic instance further comprises:
a total loss function is constructed, and the semantic instance reconstruction network is trained by using the total loss function until a preset number of iterations is satisfied, so as to obtain a trained semantic instance reconstruction network.

In some embodiments of the present disclosure, the three-dimensional point cloud of the target scene is processed by using the second target detection network to obtain second feature information of the target object, comprises:
the three-dimensional point cloud of the target scene is processed by using a VoteNet to obtain three-dimensional feature information of the target object.

In some embodiments of the present disclosure, the three-dimensional point cloud of the target scene is processed by using the VoteNet to obtain three-dimensional feature information of the target object, comprises:
feature extraction is performed on the three-dimensional point cloud of the target scene by using a PointNet of the VoteNet to obtain three-dimensional point cloud features;
central point coordinates of the target object are obtained by a multilayer perceptron network on the basis of the three-dimensional point cloud features and three-dimensional point cloud coordinates; and
a second preset number of pieces of three-dimensional feature information comprising object category information of the target object is outputted by means of the multilayer perceptron network on the basis of the central point coordinates and the three-dimensional point cloud features.

In some embodiments of the present disclosure, the initial point cloud is processed by using the preset shape generation network to obtain a semantic instance reconstruction result of the target object, comprises:
third feature information of the target object is obtained on the basis of the three-dimensional feature information and the initial point cloud;
feature extraction is performed on the third feature information by using the PointNet to obtain fourth feature information, and a target occupancy mesh of the target object is predicted by using an occupancy mesh prediction algorithm on the basis of the fourth feature information; and
the target occupancy mesh is processed by using a marching cube algorithm to obtain a semantic instance reconstruction result of the target object.

In some embodiments of the present disclosure, the target occupancy mesh of the target object is predicted by using the occupancy mesh prediction algorithm on the basis of the fourth feature information, comprises:
a probability distribution of the target object is predicted on the basis of the fourth feature information, an initial occupancy network and the initial point cloud and by using an implicit encoder in an occupancy network prediction algorithm; and
the probability distribution is sampled to obtain an implicit variable, and the target occupancy mesh of the target object is predicted on the basis of the implicit variable and the initial point cloud.

In some embodiments of the present disclosure, the total loss function is constructed, comprises:
a shape loss function is constructed on the basis of the probability distribution and the target occupancy mesh; and
the total loss function is constructed on the basis of the shape loss function and a detection loss function; wherein the detection loss function comprises a central point regression loss function, a heading angle loss regression function, a detection box size cross entropy loss function, and an object semantic category cross entropy loss function.

In some embodiments of the present disclosure, the three-dimensional detection result of the target object is predicted on the basis of the first feature information and the second feature information, so as to obtain a second coarse point cloud of the target object on the basis of the three-dimensional detection result, comprises:
a three-dimensional detection border of the target object is predicted on the basis of the first feature information and the second feature information and by using a bounding box regression network; and
point cloud information of the target object is extracted from the three-dimensional point cloud on the basis of the three-dimensional detection border so as to obtain a second coarse point cloud.

Some embodiments of the present disclosure further provide an apparatus for reconstructing semantic instance, comprising:
a feature extraction component, configured to process an original image of a target scene by using a first target detection network to obtain first feature information of a target object, and process a three-dimensional point cloud of the target scene by using a second target detection network to obtain second feature information of the target object;
a prediction component, configured to predict a first coarse point cloud of the target object on the basis of the first feature information, and predict a three-dimensional detection result of the target object on the basis of the first feature information and the second feature information, so as to obtain a second coarse point cloud of the target object on the basis of the three-dimensional detection result; and
a reconstruction result acquisition component, configured to obtain an initial point cloud of the target object on the basis of the first coarse point cloud and the second coarse point cloud, and process the initial point cloud by using a preset shape generation network to obtain a semantic instance reconstruction result of the target object.

Embodiments of the present disclosure further provide an electronic device, comprising:
a memory, for storing a computer program; and
a processor, for executing a computer program to implement the steps of the method for reconstructing semantic instance as provided above.

Some embodiments of the present disclosure further provide a non-transitory computer-readable storage medium for storing a computer program; wherein the computer program, when executed by a processor, implements the steps of the method for reconstructing semantic instance as provided above.

### BRIEF DESCRIPTION OF THE DRAWINGS

In order to describe the technical solutions in some embodiments of the present disclosure more clearly, hereinafter, accompanying drawings requiring to be used for describing the related art and the embodiments are introduced briefly. Apparently, the accompanying drawings in the following description merely relate to some embodiments of the present disclosure, and for a person of ordinary skill in the art, other accompanying drawings may also be obtained according to these accompanying drawings without involving any inventive effort.

FIG. 1 is a flowchart of a method for reconstructing semantic instance provided according to embodiments of the present disclosure;

FIG. 2 is a flowchart of a method for reconstructing semantic instance provided according to embodiments of the present disclosure;

FIG. 3 is an implementation process diagram of a method for reconstructing semantic instance provided according to embodiments of the present disclosure;

FIG. 4 is a flowchart of a method for reconstructing semantic instance provided according to embodiments of the present disclosure;

FIG. 5 is a flowchart of a method for reconstructing semantic instance provided according to embodiments of the present disclosure;

FIG. 6 is a flowchart of a method for reconstructing semantic instance provided according to embodiments of the present disclosure;

FIG. 7 is a schematic diagram of a semantic instance reconstruction result provided according to embodiments of the present disclosure;

FIG. 8 is a schematic structural diagram of an apparatus for reconstructing semantic instance provided according to embodiments of the present disclosure;

FIG. 9 is a structural diagram of an electronic device provided according to embodiments of the present disclosure; and

FIG. 10 is a structural diagram of a non-transitory computer-readable storage medium provided according to embodiments of the present disclosure.

### DETAILED DESCRIPTION OF THE EMBODIMENTS

Hereinafter, the technical solutions in embodiments of the present disclosure will be described clearly and thoroughly with reference to the accompanying drawings of the embodiments of the present disclosure. Obviously, the embodiments as described are only some of the embodiments of the present disclosure, and are not all of the embodiments of the present disclosure. All other embodiments obtained by a person of ordinary skill in the art on the basis of the embodiments of the present disclosure without any inventive effort shall all fall within the scope of protection of the present disclosure.

Current methods for reconstructing semantic instance are mostly based on a single modality, and may be mainly classified into two types: based on an RGB map and based on a three-dimensional point cloud. If only the RGB map is used, depth ambiguity will be generated, resulting in situations such as a target positioning error, etc.; and if only the three-dimensional point cloud is used for processing, the resolution of the instance reconstruction will be limited. To this end, embodiments of the present disclosure provide a method and apparatus for reconstructing semantic instance, a device and a medium, which may accurately position the location of an object and improve the quality of a semantic instance reconstruction result in a semantic instance reconstruction task.

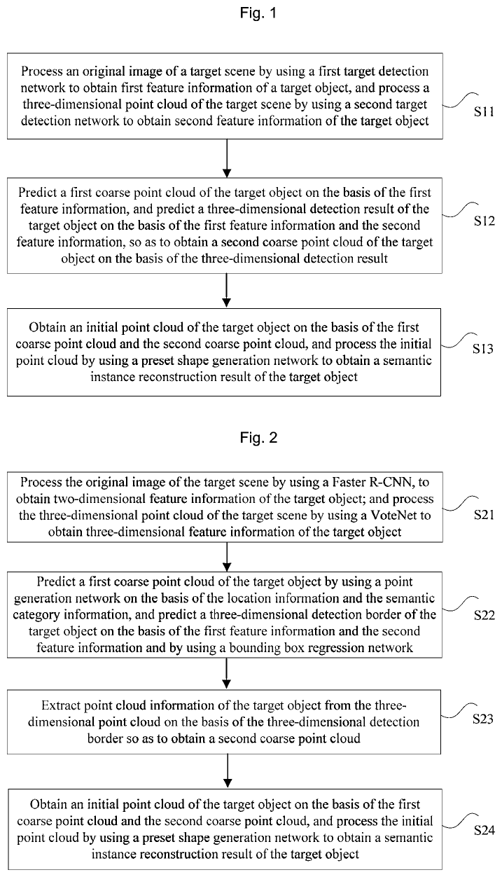

Refer to FIG. 1, embodiments of the present disclosure provide a method for reconstructing semantic instance. The method may comprise:

Step S11: an original image of a target scene is processed by using a first target detection network to obtain first feature information of a target object, and a three-dimensional point cloud of the target scene is processed by using a second target detection network to obtain second feature information of the target object.

In some embodiments of the present disclosure, First, the original image and the three-dimensional point cloud of the target scene need to be acquired, wherein the original image may be an RGB image; and the original image and the three-dimensional point cloud are processed by using a first target detection network and a second target detection network respectively, so as to obtain first feature information and second feature information corresponding to the target object in the target scene.

It should be noted that, in some embodiments of the present disclosure, the original image and the three-dimensional point cloud of the target scene are derived from a ScanNet dataset, and the ScanNet dataset comprises 1513 actual scenes in total, and a three-dimensional point cloud of the scene having instance-level labels is provided at the same time. Scan2CAD (Management Software Computer Aided Design) software aligns a three-dimensional model of an object in a ShapeNet dataset with object instances in the ScanNet dataset, and provides a reconstructed mesh of the object. In some embodiments of the present disclosure, for each scene in the ScanNet, an RGB image and a three-dimensional point cloud thereof are used as multi-modal input, in which the three-dimensional point cloud may be directly provided by a dataset, and may also be generated by using the multi-view RGB image and a depth image.

Step S12: a first coarse point cloud of the target object is predicted on the basis of the first feature information, and a three-dimensional detection result of the target object is predicted on the basis of the first feature information and the second feature information, so as to obtain a second coarse point cloud of the target object on the basis of the three-dimensional detection result.

In some embodiments of the present disclosure, a first coarse point cloud of the target object is predicted on the basis of the first feature information, and a three-dimensional detection result of the target object is predicted in combination with the first feature information and the second feature information, so as to obtain a second coarse point cloud of the target object on the basis of the three-dimensional detection result, may be: a point cloud of the target object is positioned and extracted from the three-dimensional point cloud of the target scene on the basis of the three-dimensional detection result, so as to obtain a second coarse point cloud. A three-dimensional detection result of the target object is predicted by combining the first feature information and the second feature information, so that the three-dimensional detection result is more accurate, that is, the object is positioned more accurately, and thus the quality of the second coarse point cloud obtained on the basis of the three-dimensional detection result is higher.

Step S13: an initial point cloud of the target object is obtained on the basis of the first coarse point cloud and the second coarse point cloud, and the initial point cloud is processed by using a preset shape generation network to obtain a semantic instance reconstruction result of the target object.

In some embodiments of the present disclosure, the initial point cloud of the target object is obtained by fusing the first coarse point cloud and the second coarse point cloud, and the initial point cloud is complemented and optimized by using a shape generation network, to obtain a semantic instance reconstruction result of the target object, i.e. a complete shape of the target object; and the final semantic instance reconstruction result is represented in the form of reconstructed mesh.

Hence, in some embodiments of the present disclosure, an original image of a target scene is processed by using a first target detection network to obtain first feature information of a target object, and a three-dimensional point cloud of the target scene is processed by using a second target detection network to obtain second feature information of the target object; a first coarse point cloud of the target object is predicted on the basis of the first feature information, and a three-dimensional detection result of the target object is predicted on the basis of the first feature information and the second feature information, so as to obtain a second coarse point cloud of the target object on the basis of the three-dimensional detection result; and an initial point cloud of the target object is obtained on the basis of the first coarse point cloud and the second coarse point cloud, and the initial point cloud is processed by using a preset shape generation network to obtain a semantic instance reconstruction result of the target object. Hence, in some embodiments of the present disclosure, an original image and a three-dimensional point cloud of a target scene are acquired, and the original image and the three-dimensional point cloud are processed by using a first target detection network and a second target detection network respectively, to acquire corresponding first feature information and second feature information; and then a first coarse point cloud of the target object is predicted according to the first feature information; secondly, a three-dimensional detection result of the target object is predicted by combining the first feature information and the second feature information, so that the three-dimensional detection result is more accurate, that is, the object is positioned more accurately, and thus the quality of a second coarse point cloud obtained on the basis of the three-dimensional detection result is higher; then an initial point cloud of the target object is obtained by fusing the first coarse point cloud and the second coarse point cloud, and the initial point cloud is processed by using a preset shape generation network to obtain a semantic instance reconstruction result. In this way, by combining the first feature information of the original image and the second feature information of the three-dimensional point cloud, the location of the object may be accurately positioned and the quality of the semantic instance reconstruction result may be improved.

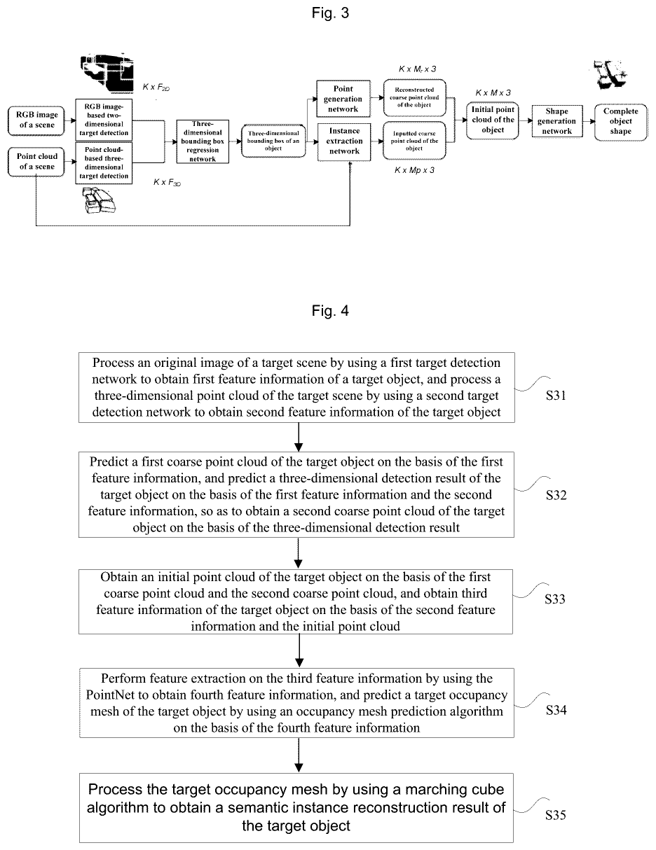

Refer to FIGS. 2 and 3, embodiments of the present disclosure provide a method for reconstructing semantic instance, which may comprise:

Step S21: the original image of the target scene is processed by using a Faster R-CNN, to obtain two-dimensional feature information of the target object; and the three-dimensional point cloud of the target scene is processed by using a VoteNet to obtain three-dimensional feature information of the target object.

In some embodiments of the present disclosure, the first target detection network and the second target detection network may be the Faster R-CNN and the VoteNet, respectively, or may be other target detection networks, which is not limited herein. Since the original image, i.e. the RGB image, of the target scene is a two-dimensional image, the Faster R-CNN is taken as a two-dimensional target detection network, and obtained feature information is two-dimensional feature information; and the three-dimensional point cloud is a three-dimensional image, the VoteNet is used as a three-dimensional target detection network, and obtained feature information is three-dimensional feature information.

Further, the original image of the target scene is processed by using the Faster R-CNN, to obtain two-dimensional feature information of the target object, comprises: feature extraction is performed on the original image of the target scene by using a convolutional layer of the Faster R-CNN, and a first preset number of pieces of two-dimensional feature information including location information and semantic category information of the target object is outputted by using an activation function. It may be understood that, the Faster R-CNN may comprise a picture feature extraction component and a candidate generation component, wherein the picture feature extraction component is configured to perform feature extraction on the original image of the target scene by using a plurality of convolutional layers, that is, feature representation of the RGB image of the scene is extracted; and the candidate generation component is configured to output a first preset number of pieces of two-dimensional feature information comprising location information and semantic category information of the target object by using an activation function, that is, object candidates are generated by using a Softmax layer. Then, given the RGB image of the target scene, the two-dimensional target detection network may output K object candidates, which are represented as K×F_{2D}, where F_{2D} is two-dimensional feature information of the object, and comprises location information and semantic category information of the target object.

The three-dimensional point cloud of the target scene is processed by using a VoteNet to obtain three-dimensional feature information of the target object, comprises: feature extraction is performed on the three-dimensional point cloud of the target scene by using a PointNet of the VoteNet to obtain three-dimensional point cloud features; central point coordinates of the target object are obtained by a multilayer perceptron network on the basis of the three-dimensional point cloud features and three-dimensional point cloud coordinates; and a second preset number of pieces of three-dimensional feature information comprising object category information of the target object is outputted by means of the multilayer perceptron network on the basis of the central point coordinates and the three-dimensional point cloud features. It may be understood that the VoteNet may comprise a point cloud feature extraction component, a vote generation component, and a candidate generation component. The feature extraction component is configured to perform feature extraction on the three-dimensional point cloud of the target scene by using the PointNet to obtain three-dimensional point cloud features, that is, a point cloud feature representation of the scene is extracted from an inputted three-dimensional point cloud; the vote generation component is configured to fuse the three-dimensional point cloud features and the three-dimensional point cloud coordinates, and generate votes by a multilayer perceptron network, which represents central point coordinates of the object; and the candidate generation component is configured to fuse the central point coordinates and nearby three-dimensional point cloud features, generate object candidates by using a multilayer perceptron, and predict object category information. Then, given the three-dimensional point cloud of the target scene, the three-dimensional target detection network outputs K object candidates, which are represented as K×M×3, wherein F_{3D} is three-dimensional feature information of the object.

Step S22: a first coarse point cloud of the target object is predicted by using a point generation network on the basis of the location information and the semantic category information, and a three-dimensional detection border of the target object is predicted on the basis of the first feature information and the second feature information and by using a bounding box regression network.

In some embodiments of the present disclosure, according to the location information and the semantic category information of the target object, by using the point generation network and the multilayer perceptron, a first coarse point cloud of the target object is predicted, which is denoted as K×Mᵣ×3. Then on the basis of the first feature information and the second feature information of the target object, that is, by fusing two-dimensional feature information and three-dimensional feature information, a feature representation K×(F_{2D}+F_{3D}) of the object is obtained; and on the basis of the feature, a three-dimensional bounding box regression network predicts a three-dimensional detection border of the object by using the multilayer perceptron.

Step S23: point cloud information of the target object is extracted from the three-dimensional point cloud on the basis of the three-dimensional detection border so as to obtain a second coarse point cloud.

In some embodiments of the present disclosure, on the basis of the three-dimensional detection border of the target object, an instance extraction component extracts point cloud information of the object from the three-dimensional point cloud of the target scene, and predicts whether the point cloud information really belongs to a current object by using a multilayer perceptron, so as to obtain a second coarse point cloud of the target object, which is denoted as K×Mₚ×3.

Step S24: an initial point cloud of the target object is obtained on the basis of the first coarse point cloud and the second coarse point cloud, and the initial point cloud is processed by using a preset shape generation network to obtain a semantic instance reconstruction result of the target object.

In some embodiments of the present disclosure, the initial point cloud K×M×3 of the target object is obtained on the basis of the first coarse point cloud and the second coarse point cloud. The initial point cloud is processed by using the preset shape generation network to obtain a semantic instance reconstruction result of the target object, that is, to obtain a complete object shape.

Hence, the first target detection network and the second target detection network may be the Faster R-CNN and the VoteNet, respectively; the original image of the target scene is processed by using the Faster R-CNN, to obtain two-dimensional feature information of the target object, and the three-dimensional point cloud of the target scene is processed by using the VoteNet to obtain three-dimensional feature information of the target object. When the second coarse point cloud of the target object is predicted on the basis of the first feature information and the second feature information, it is necessary to predict a three-dimensional detection border of the target object on the basis of the first feature information and the second feature information and by using a bounding box regression network; and point cloud information of the target object is extracted from the three-dimensional point cloud on the basis of the three-dimensional detection border so as to obtain the second coarse point cloud. By optimizing three-dimensional point cloud-based three-dimensional target detection by using RGB image-based two-dimensional target detection, a target object in a scene may be accurately positioned and extracted.

Refer to FIG. 4, embodiments of the present disclosure provide a method for reconstructing semantic instance, which may comprise:
Step S31: an original image of a target scene is processed by using a first target detection network to obtain first feature information of a target object, and a three-dimensional point cloud of the target scene is processed by using a second target detection network to obtain second feature information of the target object;
Step S32: a first coarse point cloud of the target object is predicted on the basis of the first feature information, and a three-dimensional detection result of the target object is predicted on the basis of the first feature information and the second feature information, so as to obtain a second coarse point cloud of the target object on the basis of the three-dimensional detection result; and
Step S33: an initial point cloud of the target object is obtained on the basis of the first coarse point cloud and the second coarse point cloud, and third feature information of the target object is obtained on the basis of the second feature information and the initial point cloud.

In some embodiments of the present disclosure, after the initial point cloud K×M×3 of the target object is obtained, the second feature information, i.e. three-dimensional feature information K×M×3, of the object needs to be re-fused, to obtain third feature information of the object, which is denoted as K×M×(F_{3D}+3).

Step S34: feature extraction is performed on the third feature information by using the PointNet to obtain fourth feature information, and a target occupancy mesh of the target object is predicted by using an occupancy mesh prediction algorithm on the basis of the fourth feature information.

In some embodiments of the present disclosure, feature extraction is further performed on the third feature information by using the PointNet to obtain fourth feature information, which is denoted as K×M×D_{3D}. Secondly, the target occupancy mesh of the target object is predicted by using the existing occupancy mesh prediction algorithm on the basis of the fourth feature information. The target occupancy mesh of the target object is predicted by using the existing occupancy mesh prediction algorithm on the basis of the fourth feature information, comprises: a probability distribution of the target object is predicted on the basis of the fourth feature information, an initial occupancy network and the initial point cloud and by using an implicit encoder in an occupancy network prediction algorithm; and the probability distribution is sampled to obtain an implicit variable, and the target occupancy mesh of the target object is predicted on the basis of the implicit variable and the initial point cloud. It may be understood that the shape generation network is constructed as a probability generation model; a probability distribution of the target object is predicted on the basis of the fourth feature information, an initial occupancy network and the initial point cloud and by using an implicit encoder in an occupancy network prediction algorithm, wherein the probability distribution comprises a mean value and a standard deviation, i.e. (μ, σ), such that the value thereof approximates a standard normal distribution, and an implicit variable Z is obtained by sampling from the obtained distribution (μ, σ), and the initial point cloud of the object is fused, thereby predicting the target occupancy mesh of the object.

Step S35: the target occupancy mesh is processed by using a marching cube algorithm to obtain a semantic instance reconstruction result of the target object.

In some embodiments of the present disclosure, a semantic instance reconstruction result of the object is generated from the target occupancy mesh of the target object by using the marching cube algorithm, which is a process that reconstructs mesh surface. Initially, the implicit variable is set to Z=0.

For processing processes of steps S31 and S32, reference may be made to the corresponding content provided in the embodiments above, and details will not be repeated herein.

Hence, when the initial point cloud is processed by using the preset shape generation network to obtain a semantic instance reconstruction result of the target object, the process is: third feature information of the target object is obtained on the basis of the three-dimensional feature information and the initial point cloud; feature extraction is performed on the third feature information by using the PointNet to obtain fourth feature information, and a target occupancy mesh of the target object is predicted by using an occupancy mesh prediction algorithm on the basis of the fourth feature information; and the target occupancy mesh is processed by using a marching cube algorithm to obtain a semantic instance reconstruction result of the target object. That is to say, the obtained initial point cloud is further complemented and optimized by using the shape generation network, so that a complete shape of the object may be reconstructed, and is represented by reconstructing mesh surface.

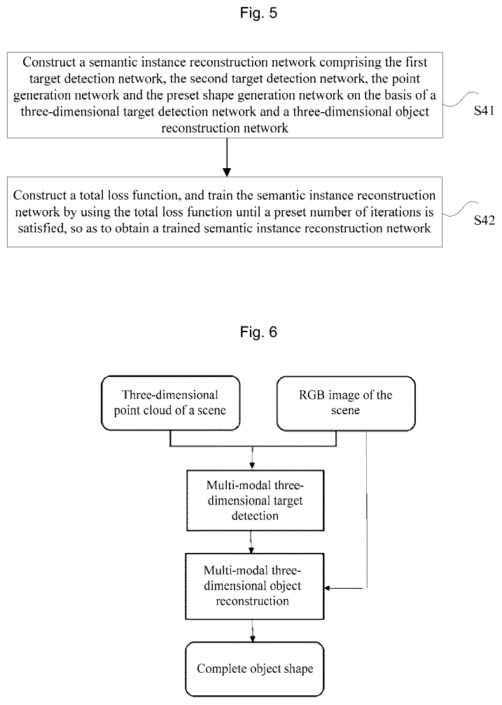

Refer to FIG. 5, the method for reconstructing semantic instance according to embodiments of the present disclosure further comprises:

Step S41: a semantic instance reconstruction network comprising the first target detection network, the second target detection network, the point generation network and the preset shape generation network is constructed on the basis of a three-dimensional target detection network and a three-dimensional object reconstruction network.

In some embodiments of the present disclosure, it may be understood that the semantic instance reconstruction network comprises two parts, i.e. the three-dimensional target detection network and the three-dimensional object reconstruction network; however, the three-dimensional target detection network includes but is not limited to, the first target detection network and the second target detection network; and the three-dimensional object reconstruction network includes but is not limited to the point generation network and the preset shape generation network. Namely, as shown in FIG. 6, a three-dimensional point cloud of a scene and an RGB image of the scene are inputted into a three-dimensional target detection network and a three-dimensional object reconstruction network in a semantic instance reconstruction network, multi-modal three-dimensional target detection and multi-modal three-dimensional object reconstruction are respectively performed, and finally a semantic instance reconstruction result, i.e. a complete object shape is outputted.

Step S42: a total loss function is constructed, and the semantic instance reconstruction network is trained by using the total loss function until a preset number of iterations is satisfied, so as to obtain a trained semantic instance reconstruction network.

In some embodiments of the present disclosure, a total loss function needs to be constructed, and the semantic instance reconstruction network is trained by using the total loss function until a preset number of iterations is satisfied, so as to obtain a trained semantic instance reconstruction network. Further, the total loss function is constructed, comprises: a shape loss function is constructed on the basis of the probability distribution and the target occupancy mesh; and the total loss function is constructed on the basis of the shape loss function and a detection loss function; wherein the detection loss function comprises a central point regression loss function, a heading angle loss regression function, a detection box size cross entropy loss function, and an object semantic category cross entropy loss function. It should be noted that the total loss function comprises two parts, i.e. a detection loss function and a shape loss function; wherein the detection loss function L_{box} adopts a common form in target detection tasks, comprising: a L1 return loss Lc of an object central point, a L1 return loss L_{θ} of a heading angle, a detection box size cross entropy loss Ls and an object semantic category cross entropy loss Lz; that is, L_{box}=L_{c}+L_{θ}+Lₛ+L_{z}. The shape loss function is constructed on the basis of the probability distribution and the target occupancy mesh, that is, for each object instance, a calculation formula of the shape loss function is:

$${L}_{shape} = \frac{1}{K} {\sum }_{i = 1}^{K} [ {\sum }_{j = 1}^{M} {L}_{ce} ( {\hat{o}}_{i , j} , {o}_{i , j} ) + KL ( \hat{p} ( {z}_{i} ) ‖ p ( {z}_{i} ) ) ] ;$$

where Lₛₕₐₚₑ represents the shape loss function, L_{ce} and KL represent the cross entropy and KL divergence, respectively; Ô_{i,j} and O_{i,j} respectively represent a predicted occupancy mesh and a truth-value occupancy mesh of a jth point of an ith object, in which the predicted occupancy mesh is also the described predicted target occupancy grid, and the truth-value occupancy mesh refers to a true occupancy mesh provided by a dataset; \hat{p}(zᵢ) and p(zᵢ) represent a predicted probability distribution and a standard normal distribution, respectively; and K and M represent dimension information of the initial point cloud, respectively. Therefore, the total loss function is: L_{pred}=L_{box}+Lₛₕₐₚₑ.

After the total loss function is constructed, the semantic instance reconstruction network is trained by using the total loss function until a preset number of iterations is satisfied, so as to obtain a trained semantic instance reconstruction network. The training process is: firstly a two-dimensional target detection network and a three-dimensional target detection network are pre-trained on an original image and a three-dimensional point cloud of a given target scene, respectively; and network parameters are fixed, and when a semantic instance reconstruction network is trained, the two-dimensional target detection network and the three-dimensional target detection network are no longer trained. An object reconstruction mesh provided by Scan2CAD is used as a supervisory information training network, and a total loss function L_{pred} with minimized gradient descent is used to train the semantic instance reconstruction network, so as to predict a complete three-dimensional object shape. When a training error of the network reaches a specified small value or satisfies a preset number of iterations, the training ends, and a trained semantic instance reconstruction network is obtained.

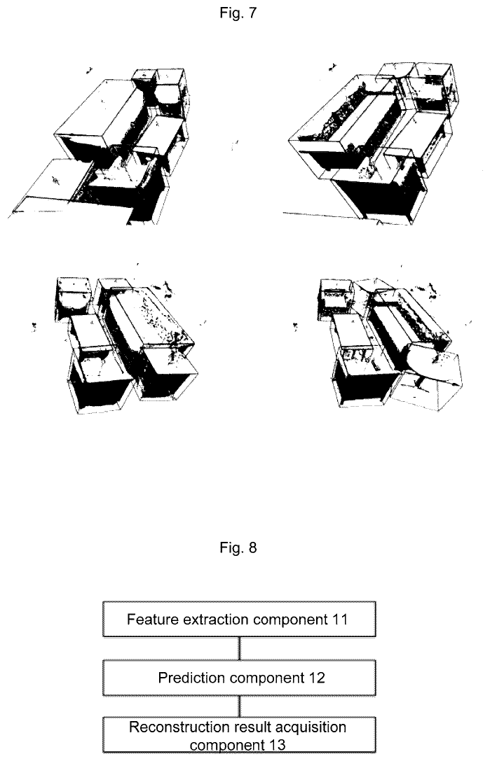

Further, a test set is inputted into the trained semantic instance reconstruction network, to test the network. An RGB image and a three-dimensional point cloud of a certain scene in a ScanNet test set may be inputted into the trained semantic instance reconstruction network, and a semantic instance reconstruction result is outputted and represented in the form of reconstructed mesh. FIG. 7 is a schematic diagram of a semantic instance reconstruction result provided according to embodiments of the present disclosure; in FIG. 7, the first column relates to a semantic instance reconstruction result, and the second column relates to corresponding truth values.

Hence, the semantic instance reconstruction network comprises two parts, i.e. the three-dimensional target detection network and the three-dimensional object reconstruction network, and therefore a method for reconstructing multi-modal two-phase semantic instance is provided. In addition, the three-dimensional target detection network further comprises the first target detection network, the second target detection network, etc.; and the three-dimensional object reconstruction network comprises the point generation network, the preset shape generation network, etc., which may improve the quality of semantic instance reconstruction by utilizing two-dimensional semantic information and three-dimensional geometric information provided by the RGB image and the three-dimensional point cloud of the scene. Furthermore, when the total loss function is constructed, construction is performed on the basis of the detection loss function and the shape loss function, to train the semantic instance reconstruction network by using the constructed total loss function, so as to obtain the trained semantic instance reconstruction network.

Refer to FIG. 8, embodiments of the present disclosure provide an apparatus for reconstructing semantic instance, the apparatus comprising:
a feature extraction component 11, configured to process an original image of a target scene by using a first target detection network to obtain first feature information of a target object, and process a three-dimensional point cloud of the target scene by using a second target detection network to obtain second feature information of the target object;
a prediction component 12, configured to predict a first coarse point cloud of the target object on the basis of the first feature information, and predict a three-dimensional detection result of the target object on the basis of the first feature information and the second feature information, so as to obtain a second coarse point cloud of the target object on the basis of the three-dimensional detection result; and
a reconstruction result acquisition component 13, configured to obtain an initial point cloud of the target object on the basis of the first coarse point cloud and the second coarse point cloud, and process the initial point cloud by using a preset shape generation network to obtain a semantic instance reconstruction result of the target object.

Hence, in some embodiments of the present disclosure, an original image of a target scene is processed by using a first target detection network to obtain first feature information of a target object, and a three-dimensional point cloud of the target scene is processed by using a second target detection network to obtain second feature information of the target object; a first coarse point cloud of the target object is predicted on the basis of the first feature information, and a three-dimensional detection result of the target object is predicted on the basis of the first feature information and the second feature information, so as to obtain a second coarse point cloud of the target object on the basis of the three-dimensional detection result; and an initial point cloud of the target object is obtained on the basis of the first coarse point cloud and the second coarse point cloud, and the initial point cloud is processed by using a preset shape generation network to obtain a semantic instance reconstruction result of the target object. Hence, in some embodiments of the present disclosure, an original image and a three-dimensional point cloud of a target scene are acquired, and the original image and the three-dimensional point cloud are processed by using a first target detection network and a second target detection network respectively, to acquire corresponding first feature information and second feature information; and then a first coarse point cloud of the target object is predicted according to the first feature information; secondly, a three-dimensional detection result of the target object is predicted by combining the first feature information and the second feature information, so that the three-dimensional detection result is more accurate, that is, the object is positioned more accurately, and thus the quality of a second coarse point cloud obtained on the basis of the three-dimensional detection result is higher; then an initial point cloud of the target object is obtained by fusing the first coarse point cloud and the second coarse point cloud, and the initial point cloud is processed by using a preset shape generation network to obtain a semantic instance reconstruction result. In this way, by combining the first feature information of the original image and the second feature information of the three-dimensional point cloud, the location of the object may be accurately positioned and the quality of the semantic instance reconstruction result may be improved.

In some embodiments of the present disclosure, the feature extraction component 11 may comprise:
a first feature extraction sub-component, configured to process the original image of the target scene by using a Faster R-CNN, to obtain two-dimensional feature information of the target object.

In some embodiments of the present disclosure, the first feature extraction sub-component may comprise:
a two-dimensional feature extraction unit, configured to perform feature extraction on the original image of the target scene by using a convolutional layer of the Faster R-CNN, and output a first preset number of pieces of two-dimensional feature information comprising location information and semantic category information of the target object by using an activation function.

In some embodiments of the present disclosure, the prediction component 12 may comprise:
a first coarse point cloud prediction unit, configured to predict a first coarse point cloud of the target object by using a point generation network on the basis of the location information and the semantic category information.

In some embodiments of the present disclosure, the apparatus for reconstructing semantic instance may further comprise:
a network reconstruction component, configured to construct a semantic instance reconstruction network comprising the first target detection network, the second target detection network, the point generation network and the preset shape generation network on the basis of a three-dimensional target detection network and a three-dimensional object reconstruction network.

In some embodiments of the present disclosure, the apparatus for reconstructing semantic instance may further comprise:
a network training component, configured to construct a total loss function, and train the semantic instance reconstruction network by using the total loss function until a preset number of iterations is satisfied, so as to obtain a trained semantic instance reconstruction network.

In some embodiments of the present disclosure, the feature extraction component 11 may comprise:
a second feature extraction sub-component, configured to process the three-dimensional point cloud of the target scene by using a VoteNet to obtain three-dimensional feature information of the target object.

In some embodiments of the present disclosure, the second feature extraction sub-component may comprise:
a three-dimensional point cloud feature extraction unit, configured to perform feature extraction on the three-dimensional point cloud of the target scene by using a PointNet of the VoteNet to obtain three-dimensional point cloud features;
a central point coordinate acquisition unit, configured to obtain central point coordinates of the target object by a multilayer perceptron network on the basis of the three-dimensional point cloud features and three-dimensional point cloud coordinates; and
a three-dimensional feature extraction unit, configured to output a second preset number of pieces of three-dimensional feature information comprising object category information of the target object by means of the multilayer perceptron network on the basis of the central point coordinates and the three-dimensional point cloud features.

In some embodiments of the present disclosure, the reconstruction result acquisition component 13 may comprise:
a third feature information acquisition unit, configured to obtain third feature information of the target object on the basis of the three-dimensional feature information and the initial point cloud;
an occupancy mesh prediction sub-component, configured to perform feature extraction on the third feature information by using the PointNet to obtain fourth feature information, and predict a target occupancy mesh of the target object by using an occupancy mesh prediction algorithm on the basis of the fourth feature information; and
an occupancy mesh processing unit, configured to process the target occupancy mesh by using a marching cube algorithm to obtain a semantic instance reconstruction result of the target object.

In some embodiments of the present disclosure, the occupancy mesh prediction sub-component may comprise:
a probability distribution prediction unit, configured to predict a probability distribution of the target object on the basis of the fourth feature information, an initial occupancy network and the initial point cloud and by using an implicit encoder in an occupancy network prediction algorithm; and
a prediction unit, configured to sample the probability distribution to obtain an implicit variable, and predict the target occupancy mesh of the target object on the basis of the implicit variable and the initial point cloud.

In some embodiments of the present disclosure, the network training component may comprise:
a shape loss function construction unit, configured to construct a shape loss function on the basis of the probability distribution and the target occupancy mesh; and
a total loss function construction unit, configured to construct the total loss function on the basis of the shape loss function and a detection loss function; wherein the detection loss function comprises a central point regression loss function, a heading angle loss regression function, a detection box size cross entropy loss function, and an object semantic category cross entropy loss function.

In some embodiments of the present disclosure, the prediction component 12 may comprise:
a three-dimensional detection border prediction unit, configured to predict a three-dimensional detection border of the target object on the basis of the first feature information and the second feature information and by using a bounding box regression network; and
a second coarse point cloud acquisition unit, configured to extract point cloud information of the target object from the three-dimensional point cloud on the basis of the three-dimensional detection border so as to obtain a second coarse point cloud.

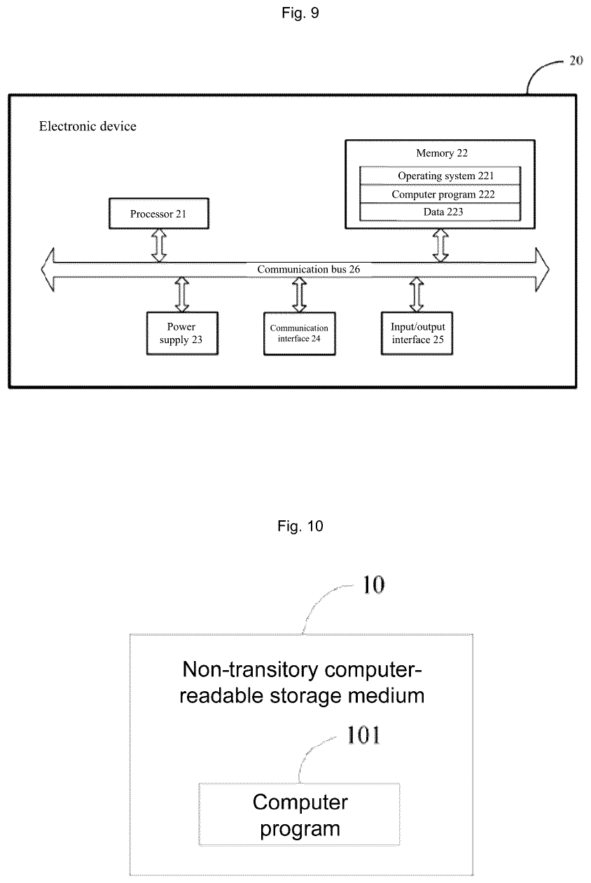

FIG. 9 is a schematic structural diagram of an electronic device provided according to embodiments of the present disclosure. The electronic device may comprise: at least one processor 21, at least one memory 22, a power supply 23, a communication interface 24, an input/output interface 25, and a communication bus 26. The memory 22 is used to store a computer program, and the computer program is loaded and executed by the processor 21, so as to implement relevant steps in the method for reconstructing semantic instance executed by the electronic device provided in any one of the embodiments above.

In some embodiments, the power supply 23 is used to provide a working voltage for each hardware device on the electronic device 20; and the communication interface 24 can establish a data transmission channel with an external device for the electronic device 20, and a communication protocol followed thereby is any communication protocol that can be applied to the technical solutions in some embodiments of the present disclosure, which will not be specifically limited herein; and the input/output interface 25 is configured to acquire external input data or output data to the outside, and the specific interface type thereof can be selected according to specific application requirements, which will not be specifically limited herein.

The processor 21 may comprise one or more processing cores, such as a 4-core processor and an 8-core processor. The processor 21 may be implemented in at least one hardware form of DSP (Digital Signal Processing), FPGA (Field-Programmable Gate Array), or PLA (Programmable Logic Array). The processor 21 may also comprise a main processor and a co-processor, wherein the main processor is a processor for processing data in a wake-up state, and is also referred to as a CPU (Central Processing Unit); and the co-processor is a low-power-consumption processor for processing data in a standby state. In some embodiments, the processor 21 may be integrated with a GPU (Graphics Processing Unit, an image processor), and the GPU is responsible for rendering and drawing content required to be displayed on a display screen. In some embodiments, the processor 21 may further comprise an AI (Artificial Intelligence) processor, and the AI processor is configured to process calculation operations related to machine learning.

In addition, the memory 22, as a carrier for resource storage, may be a read-only memory, a random access memory, a magnetic disk or an optical disk, etc.; and resources stored thereon comprise an operating system 221, a computer program 222, data 223, and the like, and the storage manner may be temporary storage or permanent storage.

The operating system 221 is used to manage and control each hardware device and the computer program 222 on the electronic device 20, so as to implement operation and processing of massive data 223 in the memory 22 by the processor 21; and the operating system may be Windows, Unix, Linux, and the like. In addition to the computer program that can be used for implementing the semantic instance reconstruction method executed by the electronic device 20 provided in any one of the embodiments above, the computer program 222 may further comprise a computer program that can be used for performing other specific operations. In addition to data received by the electronic device and transmitted from an external device, the data 223 may also comprise data collected by the input/output interface 25 of the electronic device itself.

FIG. 10 is a schematic structural diagram of a non-transitory computer-readable storage medium provided according to embodiments of the present disclosure. A computer program 101 is stored in the non-transitory computer-readable storage medium 10; and when the computer program 101 is loaded and executed by a processor, the method steps executed in the semantic instance reconstruction process according to any one of the embodiments above are implemented.

The embodiments in the present description are described in a progressive manner. Each embodiment focuses on differences from other embodiments. For the same or similar parts among the embodiments, reference may be made to each other. For the apparatus provided in the embodiments, as the apparatus corresponds to the method provided in the embodiments, the illustration thereof is relatively simple, and for the related parts, reference can be made to the illustration of the method part.

A person skilled in the art may further appreciate that units and algorithm steps in examples described in combination with the embodiments provided herein can be achieved in the form of electronic hardware, computer software, or a combination of the two. To clearly describe the interchangeability between the hardware and the software, the illustration above has generally described compositions and steps of each example according to functions. Whether these functions are executed by hardware or software depends on specific applications and design constraint conditions of the technical solutions. A person skilled in the art could use different methods to implement the described functions for each particular application, but the implementation shall not be considered to go beyond the scope of some embodiments of the present disclosure.

The steps of the method or algorithm described in conjunction with the embodiments disclosed herein may also be directly implemented by hardware, by a software component executed by a processor, or by a combination thereof. The software component may be placed in a random access memory, a memory, a read-only memory, an electrically programmable read-only memory, an electrically erasable programmable read-only memory, a register, a hard disk, a removable disk, a compact disc read-only memory, or any other form of storage medium known in the technical field.

Finally, it should also be noted that in the present text, relational terms such as first and second, etc. are only used to distinguish one entity or operation from another entity or operation, and do not necessarily require or imply any actual relationship or sequence between these entities or operations. Furthermore, the terms “comprise”, “comprising”, or any other variations thereof are intended to cover a non-exclusive inclusion, so that a process, a method, an article, or a device that comprises a series of elements not only comprises those elements, but also comprises other elements that are not explicitly listed, or further comprises inherent elements of the process, the method, the article, or the device. Without further limitation, an element defined by a sentence “comprising a . . . ” does not exclude other same elements existing in the process, the method, the article, or the device that comprises the element.

Hereinabove, a method and apparatus for reconstructing semantic instance, a device and a medium provided in the embodiments of the present disclosure are introduced in detail. The principle and embodiments of the present disclosure are described herein by applying specific examples, and the illustration of the embodiments above is only used to help understand the method and core ideas of some embodiments of the present disclosure; moreover, a person of ordinary skill in the art may make modifications to the specific embodiments and application ranges thereof according to the idea of some embodiments of the present disclosure. In conclusion, the content of the description shall not be construed as limitation to some embodiments of the present disclosure

1. A method for reconstructing semantic instance, comprising:
processing an original image of a target scene by using a first target detection network to obtain first feature information of a target object, and processing a three-dimensional point cloud of the target scene by using a second target detection network to obtain second feature information of the target object;
predicting a first coarse point cloud of the target object on the basis of the first feature information, and predicting a three-dimensional detection result of the target object on the basis of the first feature information and the second feature information;
obtaining a second coarse point cloud of the target object on the basis of the three-dimensional detection result; and
obtaining an initial point cloud of the target object on the basis of the first coarse point cloud and the second coarse point cloud, and processing the initial point cloud by using a preset shape generation network to obtain a semantic instance reconstruction result of the target object.

2. The method for reconstructing semantic instance as claimed in claim 1, wherein the original image is a Red Green Blue (RGB) image.

3. The method for reconstructing semantic instance as claimed in claim 2, wherein processing the original image of the target scene by using the first target detection network to obtain the first feature information of the target object, comprises:
processing the original image of the target scene by using a Faster Region-Convolutional Neural Network (Faster R-CNN), to obtain two-dimensional feature information of the target object.

4. The method for reconstructing semantic instance as claimed in claim 3, wherein processing the original image of the target scene by using the Faster R-CNN, to obtain the two-dimensional feature information of the target object, comprises:
performing feature extraction on the original image of the target scene by using a convolutional layer of the Faster R-CNN, and outputting a first preset number of pieces of two-dimensional feature information comprising location information and semantic category information of the target object by using an activation function.

5. The method for reconstructing semantic instance as claimed in claim 4, wherein the Faster R-CNN comprises a picture feature extraction component and a candidate generation component;
wherein the picture feature extraction component is configured to perform feature extraction on the original image of the target scene by using a plurality of convolutional layers; and
the candidate generation component is configured to output a first preset number of pieces of two-dimensional feature information comprising location information and semantic category information of the target object by using an activation function.

6. The method for reconstructing semantic instance as claimed in claim 4, wherein predicting the first coarse point cloud of the target object on the basis of the first feature information, comprises:
predicting the first coarse point cloud of the target object by using a point generation network on the basis of the location information and the semantic category information.

7. The method for reconstructing semantic instance as claimed in claim 6, wherein predicting the first coarse point cloud of the target object by using the point generation network on the basis of the location information and the semantic category information, comprises:
predicting the first coarse point cloud of the target object according to the location information and the semantic category information of the target object and by using the point generation network and a multilayer perceptron.

8. The method for reconstructing semantic instance as claimed in claim 6, wherein the method further comprises:
constructing a semantic instance reconstruction network comprising the first target detection network, the second target detection network, the point generation network and the preset shape generation network on the basis of a three-dimensional target detection network and a three-dimensional object reconstruction network.

9. The method for reconstructing semantic instance as claimed in claim 8, wherein the method further comprises:
constructing a total loss function, and training the semantic instance reconstruction network by using the total loss function until a preset number of iterations is satisfied, so as to obtain a trained semantic instance reconstruction network.

10. The method for reconstructing semantic instance as claimed in claim 9, wherein processing the three-dimensional point cloud of the target scene by using the second target detection network to obtain the second feature information of the target object, comprises:
processing the three-dimensional point cloud of the target scene by using a VoteNet to obtain three-dimensional feature information of the target object.

11. The method for reconstructing semantic instance as claimed in claim 10, wherein processing the three-dimensional point cloud of the target scene by using the VoteNet to obtain the three-dimensional feature information of the target object, comprises:
performing feature extraction on the three-dimensional point cloud of the target scene by using a PointNet of the VoteNet to obtain three-dimensional point cloud features;
obtaining central point coordinates of the target object by a multilayer perceptron network on the basis of the three-dimensional point cloud features and three-dimensional point cloud coordinates; and
outputting a second preset number of pieces of three-dimensional feature information comprising object category information of the target object by means of the multilayer perceptron network on the basis of the central point coordinates and the three-dimensional point cloud features.

12. The method for reconstructing semantic instance as claimed in claim 11, wherein the VoteNet comprises a point cloud feature extraction component, a vote generation component and a candidate generation component;
the feature extraction component is configured to perform feature extraction on the three-dimensional point cloud of the target scene by using a PointNet to obtain three-dimensional point cloud features;
the vote generation component is configured to fuse the three-dimensional point cloud features and the three-dimensional point cloud coordinates, and generate votes by the multilayer perceptron network, which represents central point coordinates of an object; and
the candidate generation component is configured to fuse the central point coordinates and nearby three-dimensional point cloud features, generate object candidates by using the multilayer perceptron, and predict object category information.

13. The method for reconstructing semantic instance as claimed in claim 11, wherein processing the initial point cloud by using the preset shape generation network to obtain the semantic instance reconstruction result of the target object, comprises:
obtaining third feature information of the target object on the basis of the three-dimensional feature information and the initial point cloud;
performing feature extraction on the third feature information by using the PointNet to obtain fourth feature information, and predicting a target occupancy mesh of the target object by using an occupancy mesh prediction algorithm on the basis of the fourth feature information; and
processing the target occupancy mesh by using a marching cube algorithm to obtain a semantic instance reconstruction result of the target object.

14. The method for reconstructing semantic instance as claimed in claim 13, wherein predicting the target occupancy mesh of the target object by using the occupancy mesh prediction algorithm on the basis of the fourth feature information, comprises:
predicting a probability distribution of the target object on the basis of the fourth feature information, an initial occupancy network and the initial point cloud and by using an implicit encoder in an occupancy network prediction algorithm; and
sampling the probability distribution to obtain an implicit variable, and predicting the target occupancy mesh of the target object on the basis of the implicit variable and the initial point cloud.

15. The method for reconstructing semantic instance as claimed in claim 14, wherein constructing a total loss function comprises:
constructing a shape loss function on the basis of the probability distribution and the target occupancy mesh; and
constructing the total loss function on the basis of the shape loss function and a detection loss function; wherein the detection loss function comprises a central point regression loss function, a heading angle loss regression function, a detection box size cross entropy loss function, and an object semantic category cross entropy loss function.

16. The method for reconstructing semantic instance as claimed in claim 1, wherein predicting the three-dimensional detection result of the target object on the basis of the first feature information and the second feature information, so as to obtain the second coarse point cloud of the target object on the basis of the three-dimensional detection result, comprises:
predicting a three-dimensional detection border of the target object on the basis of the first feature information and the second feature information and by using a bounding box regression network; and
extracting point cloud information of the target object from the three-dimensional point cloud on the basis of the three-dimensional detection border so as to obtain the second coarse point cloud.

17. The method for reconstructing semantic instance as claimed in claim 16, wherein predicting the three-dimensional detection border of the target object on the basis of the first feature information and the second feature information and by using the bounding box regression network, comprises:
fusing two-dimensional feature information and three-dimensional feature information to obtain a feature representation of the target object; and
predicting, by a three-dimensional bounding box regression network, a three-dimensional detection border of the target object by using the multilayer perceptron on the basis of the feature representation.

18. The method for reconstructing semantic instance as claimed in claim 1, wherein obtaining the initial point cloud of the target object on the basis of the first coarse point cloud and the second coarse point cloud, comprises:
fusing the first coarse point cloud and the second coarse point cloud, to obtain the initial point cloud of the target object.

19. (canceled)

20. An electronic device, comprising:
a memory, configured to store a computer program; and
a processor, configured to execute the computer program, the computer program, when executed by the processor, cause the processor to,
process an original image of a target scene by using a first target detection network to obtain first feature information of a target object, and process a three-dimensional point cloud of the target scene by using a second target detection network to obtain second feature information of the target object;
predict a first coarse point cloud of the target object on the basis of the first feature information, and predict a three-dimensional detection result of the target object on the basis of the first feature information and the second feature information;
obtain a second coarse point cloud of the target object on the basis of the three-dimensional detection result; and
obtain an initial point cloud of the target object on the basis of the first coarse point cloud and the second coarse point cloud, and process the initial point cloud by using a preset shape generation network to obtain a semantic instance reconstruction result of the target object.

21. A non-transitory computer-readable storage medium, configured to store a computer program; wherein the computer program, when executed by a processor, cause the processor to:
process an original image of a target scene by using a first target detection network to obtain first feature information of a target object, and process a three-dimensional point cloud of the target scene by using a second target detection network to obtain second feature information of the target object;
predict a first coarse point cloud of the target object on the basis of the first feature information, and predict a three-dimensional detection result of the target object on the basis of the first feature information and the second feature information;
obtain a second coarse point cloud of the target object on the basis of the three-dimensional detection result; and
obtain an initial point cloud of the target object on the basis of the first coarse point cloud and the second coarse point cloud, and process the initial point cloud by using a preset shape generation network to obtain a semantic instance reconstruction result of the target object.
